(19) United States
(12) Patent Application Publication
(10) Pub. No.: US 2020/0267364 A1
(43) Pub. Date: Aug. 20, 2020

(54) METHOD FOR DISPLAYING IMAGES OF A CAMERA SYSTEM OF A VEHICLE

(71) Applicant: Robert Bosch GmbH, Stuttgart (DE)

(72) Inventors: Jose Domingo Esparza Garcia, Stuttgart (DE); Raphael Cano, Stuttgart (DE)

(21) Appl. No.: 16/651,684

(22) PCT Filed: Sep. 10, 2018
(86) PCT No.: PCT/EP2018/074273

§ 371 Date: Mar. 27, 2020

(30) Foreign Application Priority Data
Oct. 11, 2017 (DE) 10 2017 218 090.0

(51) Int. Cl. H04N 13/111; H04N 13/15; G08G 1/14; H04N 13/282; H04N 5/232; B60R 1/00

(52) U.S. Cl. CPC H04N 13/111; H04N 13/15; G08G 1/143; H04N 13/282; B60R 2300/307; B60R 1/00; B60R 2300/20; B60R 2300/10; H04N 5/23238

(57) ABSTRACT

A method for displaying images of a camera system of a vehicle. Obstacles detected using the camera system from the surroundings of the vehicle are depicted on a display device in a virtual three-dimensional space as virtual three-dimensional objects, and it is established on the basis of a selection criterion whether the virtual three-dimensional objects and/or the virtual three-dimensional space are covered using textures which are generated by the camera system or are covered using at least one predefined texture.

### FIELD

The present invention relates to a method for displaying images of a camera system of a vehicle. In particular, the camera system is a panorama view system, which may detect images all around a vehicle.

### BACKGROUND INFORMATION

Panorama view systems are known as surround view systems (SVS) in the related art. Such systems use various data types to display a maximum number of pieces of information. In this way, the maximum number of pieces of information which the system may provide is displayed to the driver. Such data types may be obtained in particular from sensor data fusions, from pieces of information of a cloud, and from many other sources. Typical data from sensor data fusions include pieces of information about occupied and free areas around the vehicle, which are ascertained with the aid of video sensors, radar sensors, LIDAR sensors, or other surroundings sensors of the vehicle. Pieces of information from a cloud may be in particular weather conditions and available parking spaces.

Due to the variety of pieces of information which are to be displayed by the SVS, the driver of the vehicle may be overwhelmed if they are not displayed appropriately. This has the result that data are unnecessarily detected which do not supply additional value to the driver, since he/she does not recognize these pieces of information. At the same time, a very complex display is conventionally produced with substantial computing time, which integrates all pieces of information available to the surround view system in one display image. This substantial computing time is often not necessary, however, to display the presently relevant pieces of information to the driver.

### SUMMARY

An example method according to the present invention enables a display of pieces of information in different depictions. The depictions are determined on the basis of a selection criterion. In this way, it is made possible, on the one hand, to display only relevant pieces of information to the driver, on the other hand, a processing power of the system generating the display is substantially reduced.

The example method according to the present invention for displaying images of a camera system of a vehicle is provided so that obstacles detected using that camera system from the surroundings of the vehicle are depicted on a display device. The depiction takes place in a virtual three-dimensional space. In this virtual three-dimensional space, the detected obstacles are depicted as virtual three-dimensional objects. The user thus receives the impression that it is a three-dimensional display, in which three-dimensional objects are depicted. This corresponds to a virtual view of the actual scenery from a corresponding virtual camera position. An overview of the present scenery may thus be provided to the driver of the vehicle. On the one hand, to depict the relevant pieces of information optimally, on the other hand, to reduce a processing power of the system generating the depiction on the display device, it is determined on the basis of a selection criterion whether the virtual three-dimensional objects and/or the virtual three-dimensional space are covered with textures which are generated by the camera system or are covered with at least one predefined texture. The predefined texture may also be a single color in various shades, so that no texture is depicted on the display device. By dispensing with the actual textures, i.e., the textures which are generated by the camera system, on the one hand, the information content of the depiction on the display device may be reduced, on the other hand, the computing time for generating the depiction is reduced. Therefore, on the one hand, a focus on relevant pieces of information is enabled for the driver of the vehicle, on the other hand, the required processing power is significantly reduced.

Preferred refinements of the present invention are described herein.

In accordance with an example embodiment of the present invention, it is advantageously established on the basis of the selection criterion whether the textures provided for covering the virtual three-dimensional objects and/or the virtual three-dimensional space are processed with the aid of a predefined filter. In particular, a contrast of the textures may be increased by the predefined filter. The option therefore furthermore exists of depicting textures while a recognition of the virtual three-dimensional objects on the display device is improved at the same time.

In particular, it is provided that the predefined filter includes a gray shading. The gray shading reduces the color depth of the textures, whereby a contrast enhancement occurs. At the same time, the information content of the textures is reduced by the gray shading, so that a recognition of the virtual three-dimensional objects on the display device is again simplified for the driver.

The predefined texture is advantageously a predefined brightness curve. Only a contour and/or outer surfaces of the virtual three-dimensional objects are displayed by the predefined brightness curve. This means that only outlines and/or the shape of the virtual three-dimensional objects are recognizable on the display device. No texture is therefore depicted, whereby the computing time when generating the depiction on the display device is substantially reduced. At the same time, the driver of the vehicle may steer the vehicle safely and reliably through the obstacles in the surroundings, which is advantageous in particular when parking the vehicle. In particular, the driver is not distracted from the actual obstacles by the detailed textures.

In another preferred specific embodiment of the present invention, it is provided that at least a part of the virtual three-dimensional objects, in particular all virtual three-dimensional objects, are highlighted by an at least partial superposition on the display device. The superposition advantageously includes a framing of the corresponding virtual three-dimensional object. In this way, the obstacles in the surroundings may be reliably visualized. The driver of the vehicle may thus unambiguously recognize where obstacles are located in the surroundings, and whether these obstacles represent a hazard to his vehicle. Further superpositions are also advantageous, which give the driver additional indications of features in the surroundings. It is thus made possible, for example, to highlight a freely available parking space by corresponding markings on the display device.

The selection criterion is advantageously a user input. It may thus be freely selected by the user whether he/she requires a simplified depiction having at least one predefined texture or a more complex depiction having the textures of the camera system. The user may also establish whether at least a part of the textures of the camera system are to be processed using a predefined filter. The driver may thus freely select which view offers the greatest possible information content in a present situation, without being confused by a variety of presently unnecessary pieces of information.

In a further specific embodiment of the present invention, it is preferably provided that the selection criterion includes a successful recognition of a parking space and/or an activation of a parking assistance system. A change of a depiction therefore preferably takes place automatically. In this way, the presently objectively best display may be offered to the driver of the vehicle. In particular, when a parking assistance system is active, a depiction having only predefined textures may thus be used to illustrate to the driver in a simple manner which obstacles the parking assistance system has recognized and how the parking strategy takes place based on these obstacles.

The present invention additionally relates to a computer program which is configured to execute the example method as described above. The computer program is in particular a computer program including machine-readable instructions which, when they are executed on a processing device, cause the processing device to execute the steps of the above-described method. The processing device is in particular a control unit of a vehicle.

Furthermore, the present invention includes a machine-readable storage medium. The above-described computer program is stored on the machine-readable storage medium. The machine-readable storage medium is in particular an optical data carrier and/or a magnetic data carrier and/or a flash memory.

Finally, the present invention relates to an example control unit for executing the method as described above. The control unit is also advantageously designed to carry out the computer program as described above.

### BRIEF DESCRIPTION OF EXAMPLE EMBODIMENTS

Exemplary embodiments of the present invention are described in detail hereafter with reference to the figures.

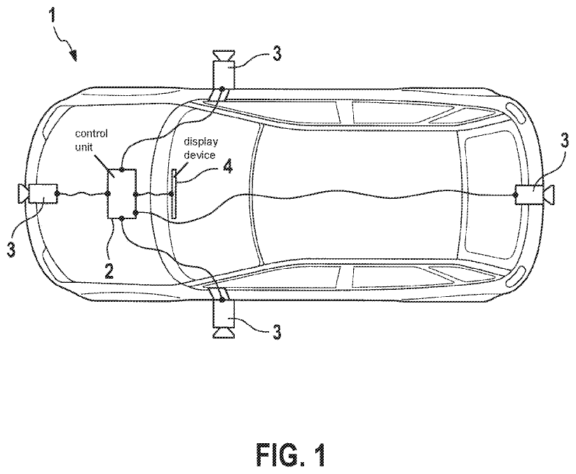

FIG. 1 shows a schematic view of a vehicle including a control unit for executing a method according to one exemplary embodiment of the present invention.

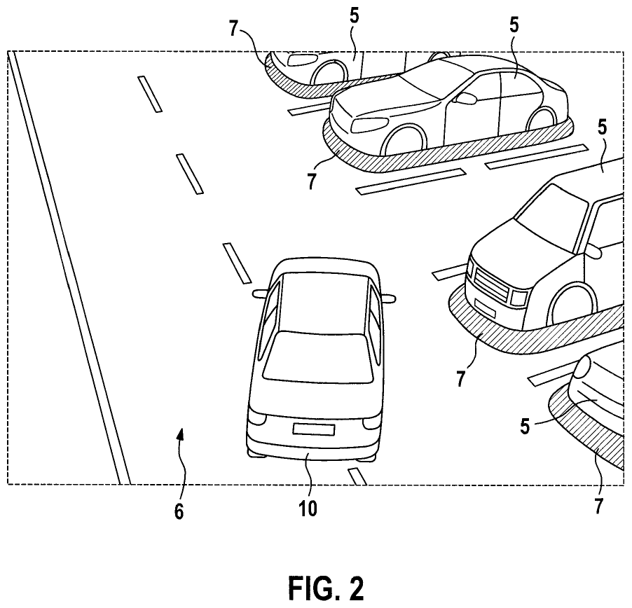

FIG. 2 shows a first example of a depiction which is generated with the aid of the method according to the exemplary embodiment of the present invention.

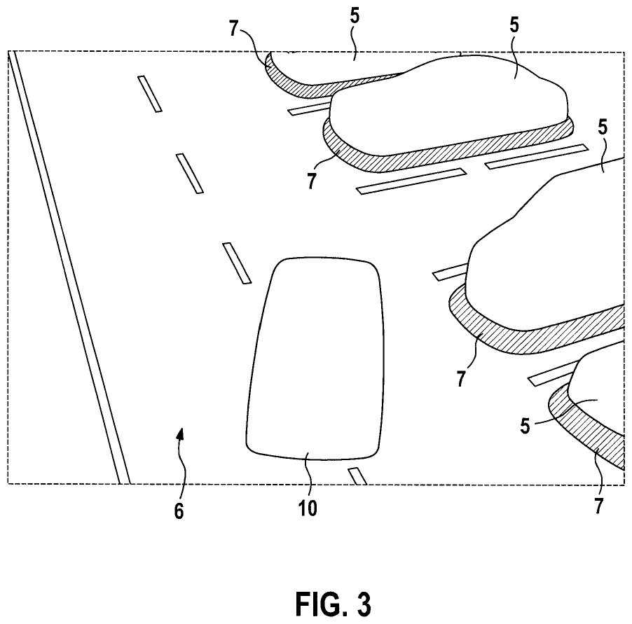

FIG. 3 shows a second example of a depiction which is generated with the aid of the method according to the exemplary embodiment of the present invention.

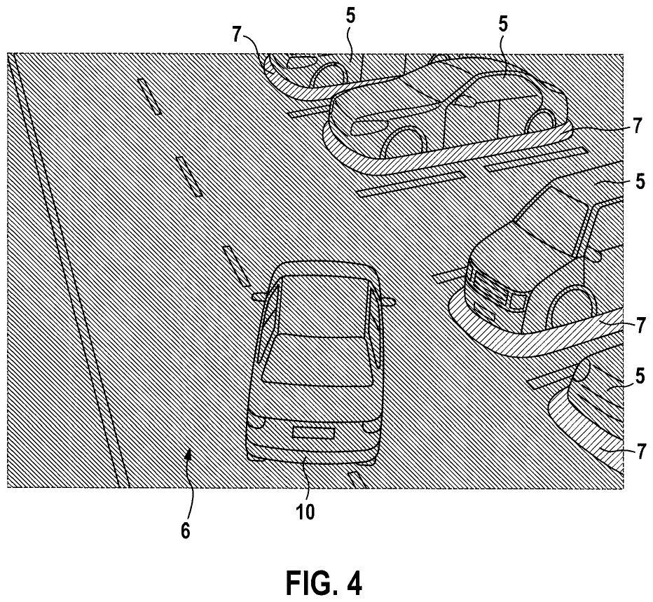

FIG. 4 shows a third example of a depiction which is generated with the aid of the method according to the exemplary embodiment of the present invention.

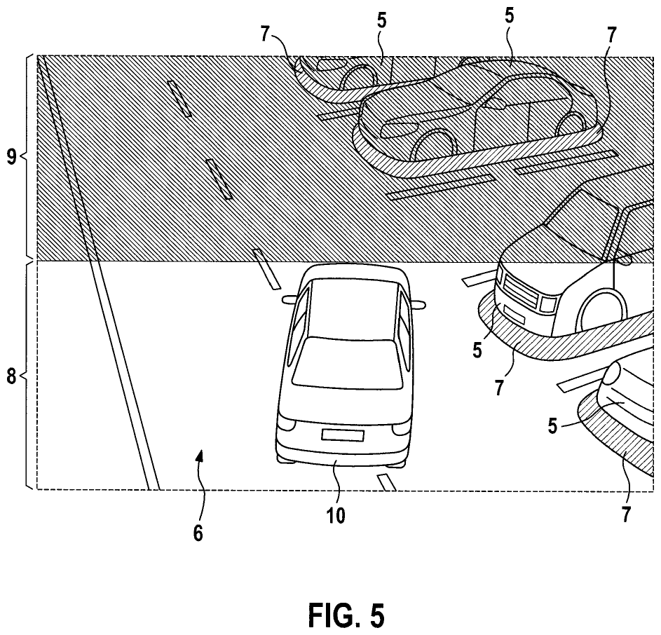

FIG. 5 shows a fourth example of a depiction which is generated with the aid of the method according to the exemplary embodiment of the present invention.

### DETAILED DESCRIPTION OF EXAMPLE EMBODIMENTS

FIG. 1 schematically shows a vehicle 1 including a control unit 2 according to one exemplary embodiment of the present invention.

Vehicle 1 includes a camera system 3, which is designed to detect surroundings around vehicle 1. The complete surroundings of vehicle 1 may thus be scanned by camera system 3. Control unit 2 is used to create a depiction on a display device 4 in order to depict the surroundings to the driver. It is provided that control unit 2 depicts the obstacles detected by camera system 3 from the surroundings of the vehicle on display device 4 in a virtual three-dimensional space 6 as virtual three-dimensional objects 5. This is shown in FIGS. 2 through 5. The selection of the depiction which is to be depicted on display device 4 is made on the basis of a selection criterion.

The selection criterion is advantageously a user input. The user may thus select which various depictions he/she wishes to observe. Alternatively, the selection criterion may be established automatically in that the depiction is selected based on a successful recognition of a parking space and/or based on an activation of a parking assistance system. The goal is always to display to the driver of the vehicle an optimum image of the surroundings, which includes relevant pieces of information without overwhelming the driver with a large variety of pieces of information. At the same time, a computing time within control unit 2 is substantially reduced by the selective choice of the depiction, since depictions having reduced information content may also be displayed on the display device and depictions having maximum information content do not have to be generated continuously.

FIG. 2 schematically shows a first example of a depiction on display device 4. Detected obstacles from the surroundings of the vehicle are depicted as virtual three-dimensional objects 5 in a virtual three-dimensional space 6. For better differentiability, it is additionally provided that frames 7 are displayed around obstacles 5. The driver of vehicle 1 may thus easily recognize the obstacles in the surroundings on the basis of virtual three-dimensional objects 5. For better clarity, it is additionally preferably provided that a representation 10 of vehicle 1 is displayed in virtual three-dimensional space 6.

In the example shown in FIG. 2, it is provided that all virtual three-dimensional objects 5 and the virtual three-dimensional space are covered by textures which were detected with the aid of camera system 3. This means that a photorealistic depiction is generated. A variety of different pieces of information is thus provided in the depiction to the driver of vehicle 1. If individual obstacles should not be recognized and are therefore also not displayed as virtual three-dimensional objects 5, the option thus still exists for the driver of recognizing these obstacles on the basis of the textures. However, the risk exists that the driver of the vehicle will be overwhelmed by a variety of pieces of information. The driver of vehicle 1 may thus possibly overlook important pieces of information, which means the risk exists that vehicle 1 will collide with an obstacle, since the driver has overlooked the approach of representation 10 of vehicle 1 to a virtual three-dimensional object 5.

A second example is shown in FIG. 3. In this example, a display takes place without textures. The scenery is the same as in FIG. 2. In contrast to FIG. 2, virtual three-dimensional objects 5 and virtual three-dimensional space 6 are not covered using textures. This means that virtual three-dimensional objects 5 and virtual three-dimensional space 6 only have a brightness curve, which includes a depiction of the outlines of virtual three-dimensional objects 5. It is again preferably provided that virtual three-dimensional objects 5 are highlighted by highlights 7.

In the depiction shown in FIG. 3, an information content is restricted solely to the presence and absence of obstacles. The driver of vehicle 1 is therefore not overwhelmed by the variety of different textures, rather the driver of vehicle 1 may concentrate on not colliding with obstacles in the surroundings, this means always maintaining a distance between representation 10 of vehicle 1 and virtual three-dimensional objects 5.

FIG. 4 finally shows a third example of the depiction. A use of textures as shown in FIG. 2 is carried out here. In contrast to FIG. 2, in this example a filter is laid over the textures. Such a filter is in particular a gray shading. A contrast of the display is thus increased, while a color depth is reduced at the same time. In this way, a depiction is implemented which switches between the depiction shown in FIG. 2 and that shown in FIG. 3 with respect to its information content. Textures are still shown to the driver of the vehicle, so that possibly not recognized obstacles may be recognized by the driver, at the same time, the recognized obstacles are reliably recognizable by the driver due to virtual three-dimensional objects 5.

Finally, FIG. 5 shows a fourth example. In this example, the depiction is divided into a first area 8 and a second area 9. First area 8 corresponds to the first example as shown in FIG. 2, while second area 9 corresponds to the third example as shown in FIG. 3. A transition of textures as generated by camera system 3 to those textures which were processed using a predefined filter thus takes place. The advantages of the high degree of detail for close range may thus be combined with the advantages of increased contrast at long range.

1-10. (canceled)

11. A method for displaying images of a camera system of a vehicle, comprising the following steps:
displaying obstacles, detected using the camera system from surroundings of the vehicle, a display device in a virtual three-dimensional space as virtual three-dimensional objects; and
establishing, based on a selection criteria, whether the virtual three-dimensional objects and/or the virtual three-dimensional space: (i) are covered using textures which are generated by the camera system, or (ii) are covered using at least one predefined texture.

12. The method as recited in claim 11, further comprising the following step:
establishing, based on the selection criterion, whether the textures provided for covering the virtual three-dimensional objects and/or the virtual three-dimensional space are processed using a predefined filter.

13. The method as recited in claim 12, wherein the predefined filter includes a gray shading.

14. The method as recited in claim 11, wherein the predefined texture is a predefined brightness curve, depict only a contour and/or outer surfaces of the virtual three-dimensional objects.

15. The method as recited in claim 11, wherein all virtual three-dimensional objects are highlighted by a framing on the display device.

16. The method as recited in claim 11, wherein the selection criterion is a user input.

17. The method as recited in claim 11, wherein the selection criterion includes a successful recognition of a parking space and/or an activation of a parking assistance system.

18. A non-transitory machine-readable storage medium on which is stored a computer program for displaying images of a camera system of a vehicle, the computer program, when executed by a computer, causing the computer to perform the following steps:
displaying obstacles, detected using the camera system from surroundings of the vehicle, a display device in a virtual three-dimensional space as virtual three-dimensional objects; and
establishing, based on a selection criteria, whether the virtual three-dimensional objects and/or the virtual three-dimensional space: (i) are covered using textures which are generated by the camera system, or (ii) are covered using at least one predefined texture.

19. A control unit configured for displaying images of a camera system of a vehicle, the control unit configured to:
display obstacles, detected using the camera system from surroundings of the vehicle, a display device in a virtual three-dimensional space as virtual three-dimensional objects; and
establish, based on a selection criteria, whether the virtual three-dimensional objects and/or the virtual three-dimensional space: (i) are covered using textures which are generated by the camera system, or (ii) are covered using at least one predefined texture.
